(19) United States
(12) Patent Application Publication
(10) Pub. No.: US 2012/0191963 A1
(43) Pub. Date: Jul. 26, 2012

(54) BIOS Updating System, BIOS Updating Method, and Related Computer Program Product

(75) Inventor: Ding-Sheng CHEN, Taipei (TW)

(73) Assignee: Elitegroup Computer System Co., Ltd., Taipei City (TW)

(21) Appl. No.: 13/243,409

(22) Filed: Sep. 23, 2011

(30) Foreign Application Priority Data
Jan. 20, 2011 (TW) 100102062

(51) Int. Cl. G06F 9/00

(52) U.S. Cl. 713/2

(57) ABSTRACT

A BIOS updating system enables a computer to perform a BIOS updating process on original BIOS data. The BIOS updating system includes: an operational module that stores updating information including BIOS updating data in a memory device when the computer runs in an operating system executing stage, sets update booting parameters, and re-boots the computer; and an updating module that executes a pre-processing process, before the execution of the BIOS updating process, when the re-booted computer runs in a POST stage, including: an inspecting unit that inspects whether the update booting parameters are set and generates update commands; and an executing unit that acquires from the memory device the BIOS updating data via the updating information according to the update commands, so as to replace the original BIOS data with the BIOS updating data, and further reboot or shut off the computer after the updating of the BIOS data.

### BACKGROUND OF THE INVENTION

1. Field of the Invention

This invention relates to BIOS updating systems, BIOS updating methods, and related computer program products, and, more particularly, to a BIOS updating system, a BIOS updating method, and a related computer program product, enabling a computer to provide a two-step BIOS updating process.

2. Description of Related Art

With the rapid development of computer products, related programs, such as application software, operating system or basic input output system (BIOS), have to be updated accordingly, in order to ensure that the computer products may run normally.

BIOS acts as a communicative bridge between hardware and software in a computer, and may check internal equipment during a power on self test (POST) procedure when the computer is turned on. The POST procedure tests various components of the computer, such as CPU, mother board, memory, CMOS storage device, connection port, display card, hard disk and keyboard. Upon finding an error, the POST procedure issues a notification or an alarm. If the BIOS has a problem, the computer cannot be turned on. Accordingly, if the computer has a hardware changed or the BIOS has a defect, the BIOS has to be updated.

In the conventional BIOS updating method, the BIOS updating data is downloaded and then recorded in a BIOS memory (BIOS ROM) in an operating system (e.g., Windows®) stage, and the operating system will not ask the computer to turn off or reboot until the BIOS updating data is recorded in the BIOS memory completely. However, some events, such as status-changing of application programs or routine programs or virus harassment, are likely to affect the recording of the BIOS updating data. As a result, the computer cannot be turned on.

Therefore, how to solve the problem that the computer cannot be turned on due to the failure of the recording of the BIOS updating data is becoming one of the most popular issues in the art.

### SUMMARY OF THE INVENTION

In view of the above-mentioned problems of the prior art, it is a primary objective of the present invention to provide a BIOS updating system, a BIOS updating method, and a related computer program product. Through storing BIOS updating data to be updated and updating the BIOS updating data during a power on self test (POST) stage when an operating system reboots, an updating failure due to unexpected circumstances occurred during an operating system executing stage is reduced.

To achieve the above-mentioned and other objectives, the present invention provides a BIOS updating system that enables a computer to perform a BIOS updating process on original BIOS data, comprising: an operational module that stores updating information including BIOS updating data in a memory device when the computer runs in an operating system executing stage, sets update booting parameters, and re-boots the computer; and an updating module that executes a pre-processing process, before the execution of the BIOS updating process, when the re-booted computer runs in a POST stage, comprising: an inspecting unit that inspects whether the update booting parameters are set and generates update commands; and an executing unit that acquires from the memory device the BIOS updating data via the updating information according to the update commands, so as to replace the original BIOS data with the BIOS updating data, and further reboot or shut off the computer after the updating of the BIOS data.

The present invention further provides a BIOS updating method that enables a computer to perform a BIOS updating process on original BIOS data, comprising: (1) when the computer runs in an operating system executing stage, storing BIOS updating data in a memory device; (2) setting update booting parameters, and rebooting the computer; and (3) when the computer is rebooted and runs in a POST stage, inspecting that the update booting parameters are set, the memory device acquiring the BIOS updating data so as to replace the previous BIOS data with the BIOS updating data.

In an embodiment of the present invention, step (3) cancels the setting of the update booting parameters after the BIOD updating data replace the previous BIOS data.

The present invention further provides a computer program product having a BIOS updating program stored therein, the BIOS updating program, when loaded in and executed by a computer, performs the BIOS updating method.

Compared with the prior art, the present invention provides a BIOS updating system, a BIOS updating method, a computer readable recording medium having a BIOS updating program stored therein, and a related computer program product, in which BIOS updating data to be updated received during an operating system executing stage are stored in a memory device, update booting parameters are detected during a POST stage when a computer reboots to determine whether a BIOS updating process should be executed, and the BIOS updating data stored in the memory device are obtained and the BIOS updating process is executed if the update booting parameters are set. In other words, the BIOS updating process is executed in the POST stage during which less interference occurs. Therefore, the BIOS updating failure because of the execution of application programs or routine programs or viruses is prevented, and the BIOS updating has a high successful rate.

### BRIEF DESCRIPTION OF DRAWINGS

The invention can be more fully understood by reading the following detailed description of the preferred embodiments, with reference made to the accompanying drawings, wherein:

FIG. 1 is a block diagram of a BIOS updating system of an embodiment according to the present invention;

FIG. 2 is an operation relation diagram illustrating a plurality of modules of the BIOS updating system operating in an operating system executing stage and a POST stage;

FIG. 3 is a flow chart of a BIOS updating method of an embodiment according to the present invention; and

FIG. 4 is a flow chart illustrating an embodiment of a BIOS updating method according to the present invention.

### DETAILED DESCRIPTION OF PREFERRED EMBODIMENTS

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

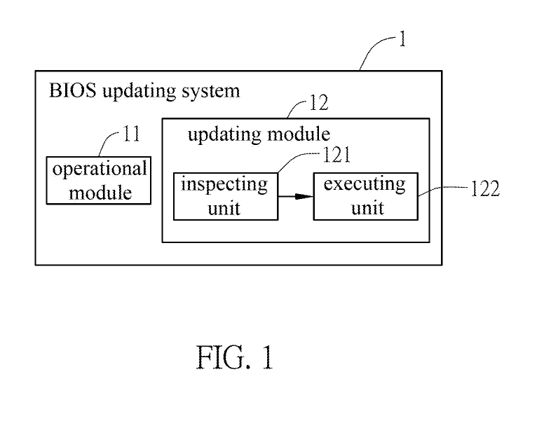

FIG. 1 is a block diagram of a BIOS updating system 1 of an embodiment according to the present invention. The BIOS updating system 1 enables a computer to obtain BIOS updating data during an operating system executing stage, and enables the computer to reboot and execute a pre-processing process during a POST stage before the execution of the BIOS updating process. According to the embodiment of the present invention, the BIOS updating system employs the operating system executing stage and the POST stage to provide a two-staged BIOS updating process. The BIOS updating system 1 includes an operational module 11 and an updating module 12.

The operational module 11, when receiving a BIOS updating request in the operating system executing stage, stores updating information including BIOS updating data into a memory device, sets update booting parameters, and then reboots the execution of the operating system. When the BIOS updating system 1 receives BIOS updating data to be updated, the operational module may store the BIOS updating data into a memory device (not shown). In an embodiment of the present invention, the BIOS updating data to be updated may be obtained from a storage device, such as a computer hard disk or an USB driver, and the memory device is a DRAM. Updating information generated when the BIOS updating data are stored may also be stored into the memory device, for subsequent searching.

The updating information further includes a signature that searches the memory device for the BIOS updating data, a boot address that stores the BIOS updating data, and a check sum of the BIOS updating data. In order to search for and identify the BIOS updating data in the memory device conveniently, the signature of the memory device and the boot address in the memory device are recorded. The so-called signature indicates a string of characters such as “$*ECSECS*$”, which facilitates the subsequent searching of the updating module 12. The check sum checks whether the obtained BIOS updating data are correct, in order to prevent the updating failure due to the wrong BIOS updating data.

Subsequently, the operational module 11 sets the update booting parameters, for obtaining commands of executing the BIOS updating process when entering the BIOS again. If the update booting parameters are not set, the operating system is executed after the POST check process. Alternatively, through the setting of the update booting parameters, the BIOS updating process is performed, and the update booting parameters are cancelled after the BIOS updating process is complete. Then, the computer reboots and enters the operating system.

In an embodiment of the present invention, the update booting parameters set identification messages in a flag manner, which may be stored in an embedded controller of the computer or a memory unit that is used for storing BIOS predetermined values. The memory unit may be a COMS memory. That is, in addition to the embedded controller, CMOS memory of the BIOS may also used for storage. Whether the BIOS boots the computer normally or the BIOS updating process is performed is determined by the setting of the update booting parameters.

The updating module 12 reboots a pre-processing process before the execution of the BIOS updating process during the operating system executing stage. The updating module 12 includes an inspecting unit 121 and an executing unit 122. Note that the updating module 12 executes during a POST stage after rebooting.

The inspecting unit 121 inspects whether to set the update booting parameters to set the computer to a BIOS updating mode, to generate update commands. That is, when the update booting parameters are set, the update commands are generated, so as to notify the executing unit 122 of executing the BIOS updating process.

The executing unit 122 obtains BIOS updating data from the memory device through the updating information according to the update commands, enabling the BIOS updating data to replace the previous BIOS data, and to reboot or ends the execution of the operating system. The executing unit 122, when receiving the update commands, obtains updating information from the memory device, and obtains BIOS updating data pre-stored in the memory device through the updating information, enabling the executing unit 122 to perform the BIOS updating process, that is, recording the BIOS updating data to replace the previous BIOS data. The operating system reboots or shuts off, so as to perform the BIOS updating process in a non-operating system stage.

In an embodiment of the present invention, the executing unit 122 further comprises canceling the setting of the update booting parameters after the BIOS updating data replace the BIOS data, that is, changing an updating mode to a normal mode. Accordingly, the computer, when rebooting, may enter the operating system smoothly.

In sum, the operational module 11 executes during the operating system executing stage, while the updating module 12 stored in the BIOS executes during a POST stage. Through the two-staged execution of the BIOS updating process, the updating is not performed during the operating system executing stage directly, and the updating failure due to unexpected circumstances of the operating system is reduced.

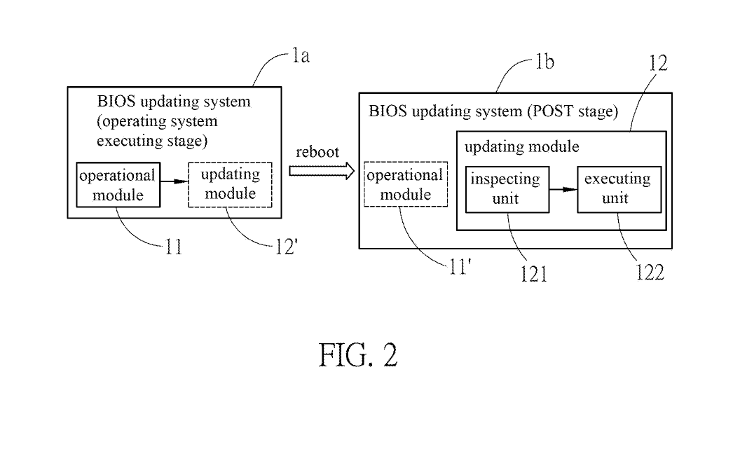

Referring to FIG. 2, it shows an operation relation diagram illustrating a plurality of modules of the BIOS updating system operating in an operating system executing stage and a POST stage. Since the present invention executes the BIOS updating process in the two-staged manner, the BIOS updating system 1a shown at the left-hand side of FIG. 2 indicates that the computer runs in the operating system executing stage, while the BIOS updating system 1b shown at the right-hand side of FIG. 2 indicates that the computer runs in a POST stage.

During the operating system executing stage, when a user obtain BIOS updating data and is going to update the BIOS, the operational module 11 of the BIOS updating system 1a stores the BIOS updating data into the memory device, and sets update booting parameters. For example, the update booting parameters are set by setting a flag value to be “1” such that, when the computer reboots, the BIOS is updated according to the update booting parameters (e.g., flag value “1”). Note that when the computer does not reboot and still runs in the operating system executing stage, the updating module 12′ does not execute any operation.

Next, the computer reboots and enters the POST stage, the updating module 12 of the BIOS updating system 1b performs a pre-processing process before the BIOS updating process, in which the inspecting unit 121 inspects whether the update booting parameters of the BIOS are set (e.g., whether the flag value is “1”); if yes, commands are transmitted to the executing unit 122, and the executing unit 122 obtains the pre-stored BIOS updating data to replace the previous BIOS data, in order to complete the BIOS updating. During the POST stage when the computer does not run in the operating system executing stage, the operational module 11′ does not execute any operation.

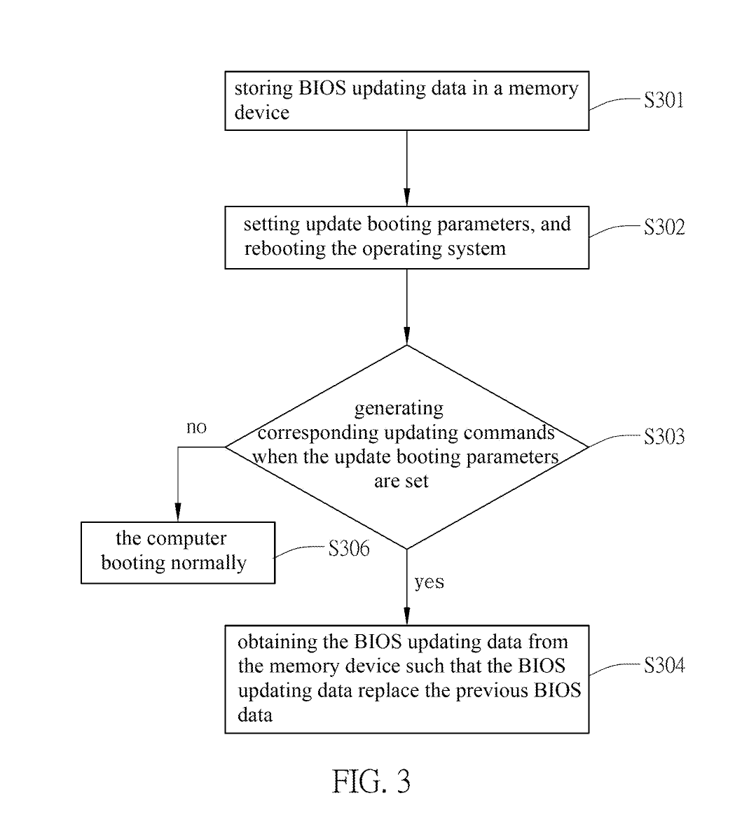

FIG. 3 is a flow chart of a BIOS updating method of an embodiment according to the present invention. In step S301, BIOS updating data to be updated are stored in a memory device. The BIOS updating data are obtained during an operating system executing stage from floppy, hard drive or other storage devices. In order to perform the BIOS updating process in a non-operating system executing stage, the BIOS updating data are stored in the memory device. Proceed to step S302.

In step S302, the update booting parameters are set, and the operating system reboots. After the BIOS updating data is stored in the memory device, the update booting parameters are set such that the computer, when rebooting and operating in the POST stage, may obtain messages indicating that the BIOS updating process is going to be performed. Proceed to step S303.

In step S303, during the POST stage whether the update booting parameters are set is determined; if determined, proceed to step S304; otherwise, proceed to step S306, in which the computer reboots normally and executes the operating system.

In step S304, the BIOS updating data are obtained from the memory device to replace the previous BIOS data, so as to complete the BIOS updating process.

Through the previous BIOS updating steps, the BIOS updating is not performed during the operating system executing stage. Therefore, the unexpected circumstances due to the execution of the BIOS updating during the operating system executing stage is prevented, and other routine programs or application programs may run normally since the updating does not occupy the system resource.

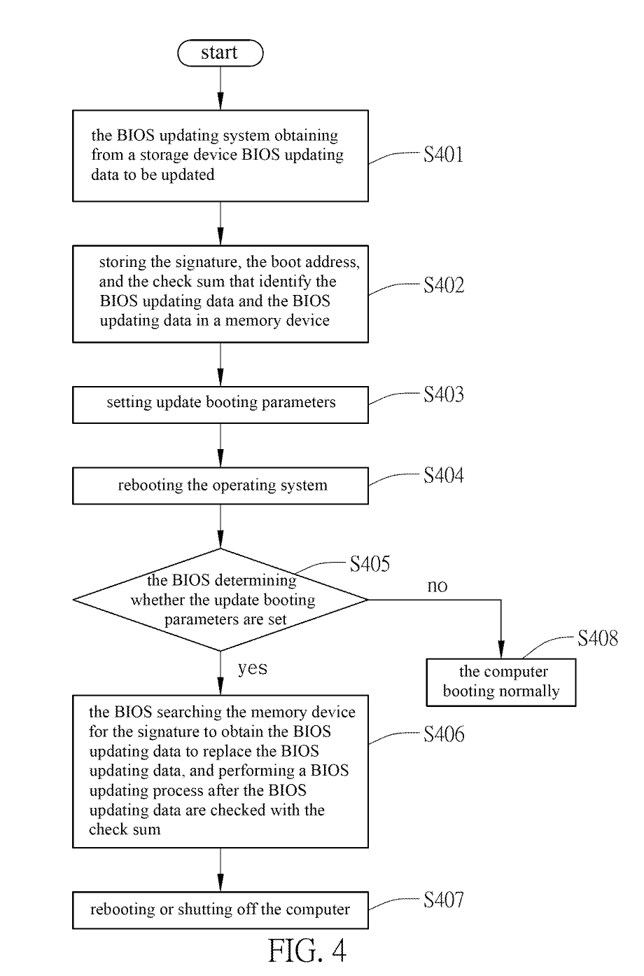

FIG. 4 is a flow chart illustrating an embodiment of a BIOS updating method according to the present invention. In step S401, the BIOS updating system obtains from a storage device, such as a hard drive or a USB drive, BIOS updating data to be updated. Proceed to step S402.

In step S402, the signature, the boot address, and the check sum that identify the BIOS updating data and the BIOS updating data are stored in the memory device. That is, the memory device is stored with BIOS updating data, the signature that searches for the BIOS updating data, the boot address that stores the BIOS updating data, and the check sum that checks the BIOS updating data, for the subsequent use of obtaining the BIOS updating data. Proceed to step S403. When storing the BIOS updating data, the updating information needed for the execution of the BIOS updating process are also stored. The updating information include a signature that identifies the BIOS updating data, a boot address and a check sum of the BIOS updating data that are stored in the memory device. The signature enables a subsequent BIOS to search the memory device for the BIOS updating data conveniently, and the check sum is used for checking whether the obtained BIOS updating data are wrong after the BIOS updating data are obtained.

In step S403, the update booting parameters are set. The update booting parameters are set for the computer to execute the BIOS updating process after the computer reboots and runs in the POST stage. Proceed to step S404.

In step S404, the operating system reboots. That is, the computer reboots during the operating system executing stage after the BIOS updating data are stored, such that the BIOS updating process may be performed in the POST stage. Proceed to step S405.

In step S405, during the POST stage the BIOS determines whether the update booting parameters are set; it set, proceed to step S406; otherwise, proceed to step S408, enabling the computer to reboots normally and does not execute the BIOS but executes the operating system.

In step S406, the BIOS searches the memory device for the signature to obtain the BIOS updating data, and executes the BIOS updating process after the BIOS updating data are checked with the check sum. After the BIOS obtains the BIOS updating data from the previously stored updating information, the BIOS updating process may be performed. After the BIOS updating process is complete, proceed to step S407, during which the computer reboots or shuts off.

Since the BIOS updating method according to the present invention can be applied to the system architecture of FIG. 1, and the system architecture can be installed in a computer, a user is enabled to execute the BIOS updating method at a local computer. The computer, after reading and executing the BIOS updating program, realizes the BIOS updating method of the present invention. The BIOS updating program can be stored in a computer readable recording medium, such as a hard disk, a floppy, a versatile disk, memory card or USB drive, or be downloaded by the computer via a network system from a network server. The computer can also download and execute the BIOS updating program from an electronic product at another end through a transmission medium, such as a connection line or a wireless network. Accordingly, the present invention further provides a computer readable recording medium having a BIOS updating program stored therein and a computer program product having the BIOS updating program stored therein, the BIOS updating program, when executed by a computer, can perform the BIOS updating method illustrated in FIGS. 3 and 4. Alternatively, the computer program product may include the computer readable recording medium, in which the BIOS updating program is stored.

In conclusion, the BIOS updating system, the BIOS updating method, the computer readable recording medium and the computer program product of the present invention store BIOS updating data to be updated into a memory device, and executes a BIOS updating process during a POST stage after the computer reboots. Therefore, the BIOS updating process is performed in the POST stage during which less interferences occur, and the BIOS updating failure because of the unexpected circumstances of application programs, routine programs or viruses is prevented. The BIOS updating process is thus performed more perfectly, and the system resource exhaustion or executing programs executing wrongly doe to the execution of the BIOS updating during the operating system executing stage is reduced.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A BIOS updating system that enables a computer to perform a BIOS updating process on original BIOS data, comprising:
an operational module that stores updating information including BIOS updating data in a memory device when the computer runs in an operating system executing stage, sets update booting parameters, and re-boots the computer; and
an updating module that executes a pre-processing process, before the execution of the BIOS updating process, when the re-booted computer runs in a POST stage, comprising:
an inspecting unit that inspects whether the update booting parameters are set and generates update commands; and
an executing unit that acquires from the memory device the BIOS updating data via the updating information according to the update commands, so as to replace the original BIOS data with the BIOS updating data, and further reboot or shut off the computer after the updating of the BIOS data.

2. The BIOS updating system of claim 1, wherein the updating information further include a signature that searches for the BIOS updating data, a boot address that stores the BIOS updating data, and a check sum of the BIOS updating data.

3. The BIOS updating system of claim 1, wherein the update booting parameters are stored in an embedded controller of the computer or stored in a memory where BIOS predetermined values are stored.

4. The BIOS updating system of claim 1, wherein the executing unit further comprises canceling the setting of the update booting parameters after the BIOS updating data replace the previous BIOS data.

5. A BIOS updating method that enables a computer to perform a BIOS updating process on original BIOS data, comprising the steps of:
(1) when the computer runs in an operating system executing stage, storing BIOS updating data in a memory device;
(2) setting update booting parameters, and rebooting the computer; and
(3) when the computer is rebooted and runs in a POST stage, inspecting that the update booting parameters are set, the memory device acquiring the BIOS updating data so as to replace the previous BIOS data with the BIOS updating data.

6. The method of claim 5, wherein the step (1) further includes recording the signature, the boot address and the check sum generated when the BIOS updating data are stored, enabling the step (3) to obtain the BIOS updating data through the updating information.

7. The method of claim 5, wherein when the update booting parameters in step (3) are not set, the memory device does not obtain the BIOS updating data in step (3), and the computer boots normally to execute the operating system.

8. The method of claim 5, wherein the step (3) cancelled the setting of the update booting parameters after the BIOS updating data replace the previous BIOS data.

9. The method of claim 5, further comprising the step of: (4) rebooting or shutting off the computer after the BIOS updating data replace the previous BIOS data.

10. A computer program product having BIOS updating program stored therein, the BIOS updating program, when loaded in and executed by a computer, performing the method of claim 5.
